(19) United States
(12) Patent Application Publication
(10) Pub. No.: US 2019/0028266 A1
(43) Pub. Date: Jan. 24, 2019

(54) DYNAMIC ENCRYPTION OF CPU REGISTERS

(71) Applicant: Cisco Technology, Inc., San Jose, CA (US)

(72) Inventors: David DARMON, Jerusalem (IL); Avi Klein, Elazar (IL); Yaacov Belenky, Maaleh Adumim (IL)

(21) Appl. No.: 15/657,159

(22) Filed: Jul. 23, 2017

(51) Int. Cl. H04L 9/06; H04L 9/08

(52) U.S. Cl. CPC H04L 9/0662; H04L 9/0869; H04L 9/0822

(57) ABSTRACT

In one embodiment, a system and method is described for dynamic encryption of CPU registers. A data item, encrypted according to a first key is stored in one register in a CPU register file. A second data item is encrypted according to a second key, and is written to another of the registers. A flag, associated with each of the registers, is stored, indicating whether the data item is encrypted according to the first or second key. One of the data items is decrypted by retrieving its associated flag, thereby determining according to which key the data item is encrypted. Thereupon, the data item is decrypted according to the determined key. The keys are updated by a controller once each of the flags are set. The controller changes the second key to be the first key, stores a new second key, and clears each of the flags. Related apparatus, systems and methods are also described.

### TECHNICAL FIELD

The present disclosure generally relates to secure central processing units (CPUs).

### BACKGROUND

A secure central processing unit (CPU) is intended to make it possible to perform calculations that involve secret values in such a way that it is difficult to get unauthorized access to the secret values. If the secret values handled by code running in the secure CPU are important enough, attackers may have motivation to use resource intensive and delicate means, such as physical probing, in order to steal these secrets or some part of them.

Secure CPUs include cryptoprocessors, such as those found on smart cards, trusted platform modules, security chips for embedded systems, and so forth as is known in the art. Unfortunately, secure CPUs are not invulnerable to attack, particularly for well-equipped and determined opponents (e.g. by an intelligence agency, by way of a non-limiting example) who are willing to expend massive resources on an attack of the secure CPU.

### BRIEF DESCRIPTION OF THE DRAWINGS

The present disclosure will be understood and appreciated more fully from the following detailed description, taken in conjunction with the drawings in which:

FIG. 1 is a simplified block diagram illustration of one embodiment of an embodiment of a secure processing system constructed and operative in accordance with an embodiment of the present disclosure;

FIG. 2 is a circuit diagram describing an implementation of the embodiment of the system of FIG. 1;

FIG. 3 is a timing diagram, showing the use of keys over time with respect to encrypted registers in the CPU of FIG. 1; and

FIG. 4 is a flow chart is a flow chart of a method of operation for an embodiment of the present disclosure.

### DESCRIPTION OF EXAMPLE EMBODIMENTS

### Overview

In one embodiment, a system and method is described for dynamic encryption of CPU registers. A data item, encrypted according to a first key is stored in one register in a CPU register file. A second data item is encrypted according to a second key, and is written to another of the registers. A flag, associated with each of the registers, is stored, indicating whether the data item is encrypted according to the first or second key. One of the data items is decrypted by retrieving its associated flag, thereby determining according to which key the data item is encrypted. Thereupon, the data item is decrypted according to the determined key. The keys are updated by a controller once each of the flags are set. The controller changes the second key to be the first key, stores a new second key, and clears each of the flags. Related apparatus, systems and methods are also described.

### Exemplary Embodiment

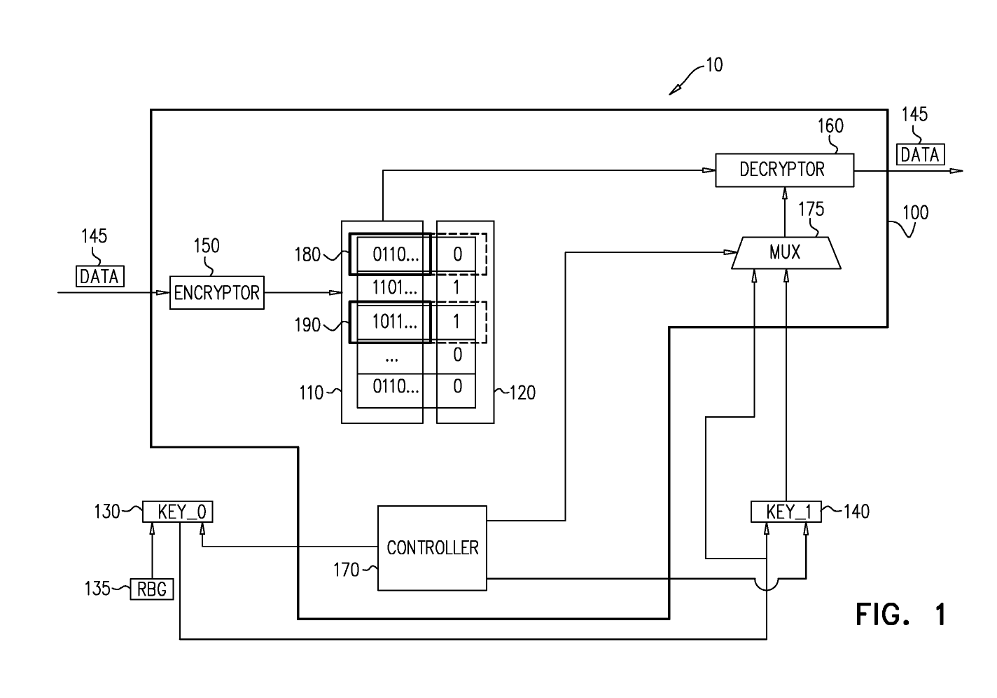

Reference is now made to FIG. 1, which is a simplified block diagram illustration of an embodiment of a secure processing system 10 constructed and operative in accordance with an embodiment of the present disclosure. The secure processing system 10 of FIG. 1 comprises a secure CPU 100, which itself comprises a CPU register file 110, a plurality of flags 120 associated with a plurality of registers making up the CPU register file 110, an encryptor 150, a decryptor 160, a controller 170, and at least one multiplexer 175 (denoted MUX in the figure).

The secure processing system 10 also comprises two encryption keys. A first encryption key 140 (denoted KEY_1 in the figure), and a second encryption key 130 (denoted KEY_0 in the figure). The two encryption keys are stored outside of the CPU 100, for use in the operation of the secure processing system 10 of FIG.

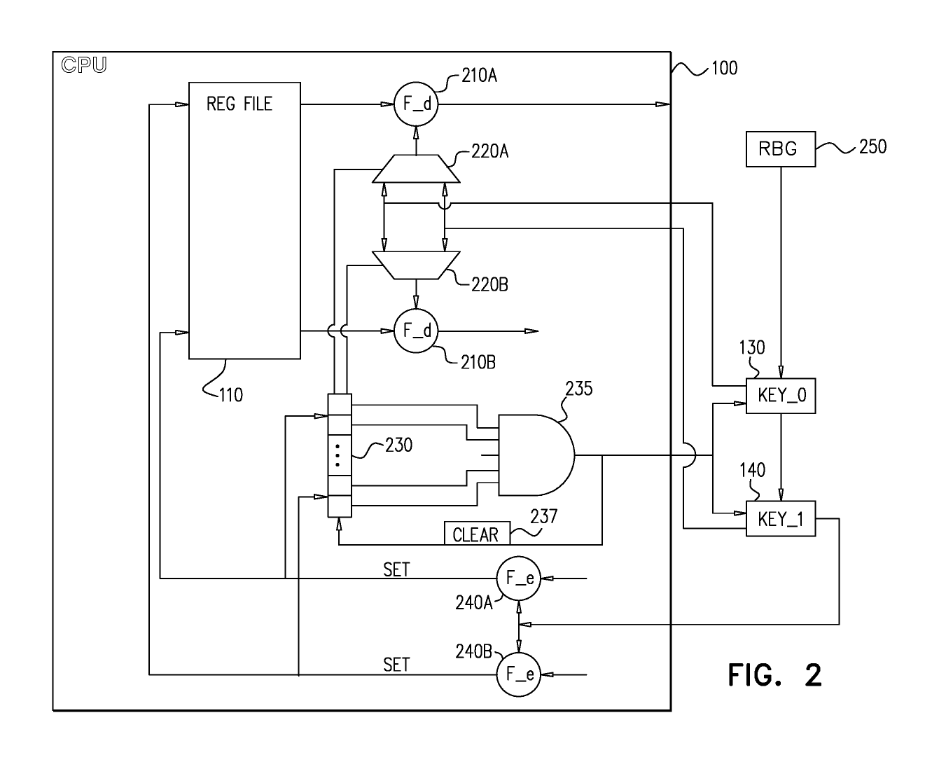

1. The first encryption key 140 and the second encryption key 130 are typically stored in memory (not depicted) external to the CPU 100. A random bit generator (RBG) 135, external to the CPU 100, is utilized in generation of the second encryption key 130, as will be explained below, with reference to FIG. 2.

As noted above, if secret values which are used in operation by software running in the secure CPU 100 are valuable enough, attackers may have motivation to use costly and delicate means, such as physical probing, in order to steal these secret values or some part of the secrets (which may themselves be of use to the attackers). The CPU register file 110, where the secret values are stored, may be vulnerable to some forms of probing used by attackers, since, in order for the secure CPU 100 to use any data 145 (such as the secret values mentioned above), that data 145 must first be loaded to a one register of the CPU register file 110 (e.g., one of registers 180 and 190). Some systems try to avoid this vulnerability by first encrypting the data 145 before loading it to the one register (e.g., one of registers 180 and 190) of the CPU register file 110, and then decrypting the data 145 before it is used. However, such encryption and decryption operations are typically performed quickly and therefore are typically cryptographically weak operations, as there is typically not adequate time to perform complex cryptographically strong operations. If, in at least some cases the attackers know or correctly guesses a plaintext value (such as the data 145), which may be read by probing the register file, then the attackers effectively know pairs of plaintext data (such as the data 145) and its corresponding ciphertext value. In such cryptographically weak systems, when enough pairs of plaintext-ciphertext data are collected, the attackers may be able to determine or guess an encryption key, (such as first encryption key 140 and second encryption key 130) and thus, compromise the encryption.

In embodiments, the encryption key (such as first encryption key 140 and second encryption key 130) is changed from time to time. If time between two consecutive changes of the key is short enough, then, it is believed by the inventors that the attackers will not have sufficient time to collect enough data necessary to find the encryption key.

The operation of the system of FIG. 1 is now described. The secure processing system 10, is provided with two memory slots, external to CPU 100, for local encryption keys, i.e., first encryption key 140 (KEY_1) and second encryption key 130 (KEY_0). As will be explained below, at a later stage, the second encryption key 130 becomes the first encryption key 140 by assuming the value of the first encryption key 140. Accordingly, in some embodiments, each one of the plurality of flags 120 is typically a single bit flag, and may also be referred to as CurrentKey. CurrentKey typically indicates which of the two memory slots is storing the first encryption key 140, and which is storing the second encryption key 130. Thus, rather than storing each key of the two keys in a fixed location, and moving KEY_0 to the fixed location of KEY_1 at an appropriate time, transitioning the first encryption key 140 to become the second encryption key 130 may entail updating the CurrentKey flag.

Each one register of the CPU register file 110 has an associated flag of the plurality of flags 120 that indicates whether the one register of the CPU register file 110 is encrypted with the first encryption key 140 or the second encryption key 130. By way of example, in FIG. 1, a first exemplary one register 180 (indicated by a bold box) of the CPU register file 110 has its associated flag (indicated with an attached dotted lined box) of the plurality of flags 120 set to 0, and is, by way of example, encrypted with the second encryption key 130. In contrast, a second exemplary one register 190 (indicated by a bold box) of the CPU register file 110 has its associated flag (indicated with an attached dotted lined box) of the plurality of flags 120 set to 1, and is, by way of example, encrypted with the first encryption key 140. It is appreciated that in the present description, a flag value of “0” is associated with Key_0 and a flag value of “1” is associated with Key_1. This is a convenience for ease of description, and not meant to be limiting. The associated flag of the plurality of flags 120 may be referred to as the NewKeyValid field for its associated one register of the CPU register file 110.

When a new value is written to one register of the CPU register file 110, the new value is encrypted with KEY_1 (i.e., key[CurrentKey]), and its associated flag NewKeyValid is set to 1.

A hardware controller mechanism 170 for updating the system of FIG. 1, described below with reference to FIG. 2, detects when all of the flags of the plurality of flags 120 associated with the plurality of registers making up the CPU register file 110 are set (i.e., all of the flags of the plurality of flags 120 indicate that their associated register of the CPU register file 110 is encrypted with the second encryption key 130). When the hardware controller mechanism 170 detects that all of the flags of the plurality of flags 120 associated with the plurality of registers making up the CPU register file 110 are set, the hardware controller mechanism 170 performs the following actions, typically in a single clock cycle:
The CurrentKey flag, indicating which of the two encryption keys is KEY_0 and which is KEY_1 is flipped. Effectively, this means that KEY_0 assumes the value of KEY_1, thereby effectively becoming KEY_1. Note that KEY_1 is an immediately previous value of KEY_0 in the system of FIG. 1;
All of the flags of the plurality of flags 120 associated with a plurality of registers making up the CPU register file 110 are reset to 0; and
A new key, which becomes the first encryption key 140 is randomly generated by the RBG 135 and is stored in one of the two memory slots for local encryption keys by the updating hardware controller mechanism 170.

When a value is read from one of the plurality of registers making up the CPU register file 110 (e.g., the “1011 . . . ” from item 190), the value is first decrypted by the decryptor 160, using an appropriate decryption key as indicated by the associated flag of the plurality of flags 120 (e.g., “1”, indicating KEY_1, for the CPU register value “1011 . . . ” of item 190). The decryption of the value by the decryptor 160 restores the data 145 to its unencrypted state.

As will be explained below with reference to FIG. 2, the multiplexer (MUX) 175 functions as a switch to determine which of the two keys, KEY_0 and KEY_1 to use. It is appreciated that the encryption/decryption scheme described herein is a symmetric encryption/decryption scheme, and therefore, the same key is used for both encryption and decryption. As such, the use of the term “encryption key” and “decryption key” is a matter of context. Both terms are referring to a single key.

As mentioned above, the encryption key (i.e., first encryption key 140 and second encryption key 130) is changed from time to time. If the time between two consecutive changes of the key is short enough, the attackers will not have enough time to collect an adequate amount of data necessary to find the encryption key. Accordingly, a new second encryption key 130 is generated frequently by the RBG 175 in order to maintain security for the secure processing system 10 of FIG. 1. The inventors have performed simulations on secure CPUs, such as secure CPU 100, and in the course of regular operations, the plurality of flags 120 (i.e., the NewKeyValid field) are updated frequently enough that the first encryption key 140 is generated frequently enough to maintain security of the system of FIG. 1.

In some embodiments, however, a software driver (not depicted) may be triggered by a timer or other appropriate mechanism to ensure that all of the plurality of registers making up the CPU register file 110 are read frequently enough thereby resulting in a new second encryption key 130 being generated by the RBG 175. Alternatively, a hardware mechanism may perform periodic reading of the plurality of registers making up the CPU register file 110, re-writing the same value to the register from which the value was read, while changing the value of the associated flag of the plurality of flags 120 for each register, thereby resulting in all of the flags of the plurality of flags 120 associated with the plurality of registers making up the CPU register file 110 being set.

Persons of skill in the art will also appreciate that even if the current encryption key is in use long enough for the attackers to reveal the current key, the attackers still need to figure out which registers of the plurality of registers making up the CPU register file 110 are encrypted with the current encryption key, i.e., the first encryption key 140, and which registers of the plurality of registers making up the CPU register file 110 are encrypted with the new encryption key, i.e., the second encryption key 130. Accordingly, knowledge of the encryption key is a necessary but not sufficient condition for accessing the data stored in the plurality of registers making up the CPU register file 110.

Reference is now made to FIG. 2, which is a circuit diagram describing an implementation of the embodiment of the system of FIG. 1.

The CPU 100 comprises the CPU register file 110 (RegFile). The CPU 100 also comprises decryption functions 210A, 210B which are implemented in hardware. Decryption functions 210A, 210B receive the values of individual registers in the CPU register file 110 and decrypt them, according to the key (either first encryption key 140 or second encryption key 130) by which they are encrypted.

The first encryption key 140 and the second encryption key 130, are provided to multiplexers 220A, 220B. A flag of the plurality of flags 120 associated with the appropriate register of the individual registers in the CPU register file 110 (i.e. the NewKeyValid field) is provided as an input to the multiplexers 220A, 220B from a memory 230. On the basis of a value of the flag, the multiplexers 220A, 220B provide one of either the first encryption key 140 or the second encryption key 130 to the decryption functions 210A, 210B. The flag is stored in a memory 230, from which it is provided to the multiplexers 220A, 220B. The memory 230 is provided to store the flag associated with each one register in the register file 110. Each flag associated with each one register in the register file 110 indicates whether the one register in the register file is encrypted according to the first encryption key 140 or the second encryption key 130.

The encryption functions 240A, 240B, which are implemented in hardware, receive the values to be stored in the individual registers in the CPU register file 110 and encrypt them, according to the first encryption key 140 as discussed above with reference to FIG. 1. When the encryption functions encrypt the values to be stored in the individual registers in the CPU register file 110, the flag (corresponding to one of the plurality of flags 120 of FIG. 1) stored in memory 230 for the encrypted value of the individual register is then set.

The plurality of flags 120 (FIG. 1) stored in memory 230 are logically AND-ed together once a clock cycle by an appropriate logic circuit 235, such as a plurality of AND gates. As those of skill in the art are aware, other combinations of logic gates may be combined as an appropriate circuit, achieving the same result as the plurality of AND gates. Accordingly, it is appreciated that any appropriate circuit may be used, and the use of AND gates in the depiction of FIG. 2 is by way of example only. If all of the flags of the plurality of flags 120 (FIG. 1) are set, then the result of the logical AND-ing will be TRUE, causing the flags to be reset (i.e., Clear 237), and changing the value of the CurrentKey flag, so that, KEY_0 becomes KEY_1, and accordingly, a new KEY_0 is generated.

It is appreciated that CPU 100 comprises, in addition to the appropriate logic circuit 235, dedicated hardware logic circuits, in the form of an application-specific integrated circuit (ASIC), field programmable gate array (FPGA), or full-custom integrated circuit, or a combination of such devices.

Alternatively or additionally, some or all of the functions described herein may be carried out by a programmable processor or digital signal processor (DSP), under the control of suitable software. This software may be downloaded to the processor in electronic form, over a network, for example. Alternatively or additionally, the software may be stored on tangible storage media, such as optical, magnetic, or electronic memory media.

A random bit generator (RBG) 250, which might be a true random bit generator or a pseudo-random bit generator, provides a random string of bits which become the first encryption key 140. The random string of bits may undergo further manipulation in order to add additional entropy to the system. By way of example, the random string of bits may be processed through a shift register (not depicted), which may comprise a linear-feedback shift register prior to being stored as the first encryption key 140.

It will be apparent to one of ordinary skill in the art that one or more of the components of the exemplary CPU 100 may not be included in some embodiments, and other components may be added in some embodiments, as is known in the art. The exemplary CPU 100 shown in FIGS. 1 and 2 is provided as an example of a possible platform that may be used, and other types of platforms may be used as is known in the art. One or more of the steps described above may be implemented as instructions embedded on a computer readable medium and executed on the exemplary CPU 100. The steps may be embodied by a computer program, rather than occurring in hardware, as described above. Said computer program may exist in a variety of forms both active and inactive. For example, the computer program may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks.

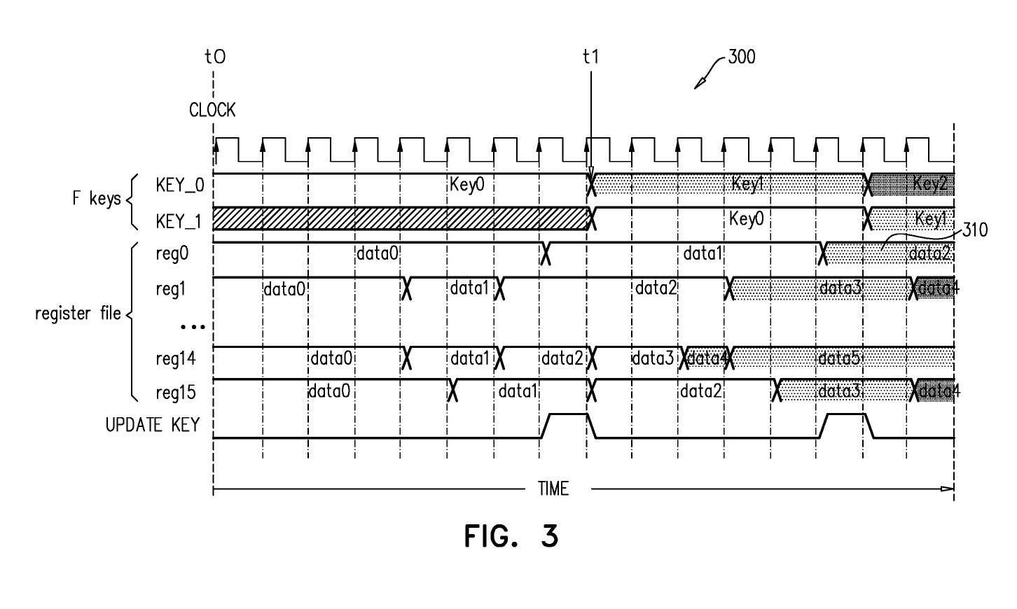

Reference is now made to FIG. 3, which is a timing diagram 300, showing the use of keys over time with respect to encrypted registers in the secure CPU 100 of FIG. 1. Time progresses through the timing diagram 300 from left to right. At the start of a scenario presented in the timing diagram 300, data contents of the register file 110 (FIGS. 1 and 2) (denoted reg0, reg1, . . . reg14, reg15 in the timing diagram 300) are encrypted by either one of the encryption function 240A or the encryption function 240B (FIG. 2) using the first encryption key 140. From time t0 to time t1, there is no value for the second encryption key 130. The string of bits comprising the first encryption key 140 is indicated by Key₀ in the timing diagram 300.

After a certain number of clock cycles, all of the registers of the register file 110 are full, and at a time indicated by t1 in the timing diagram 300, the string of bits comprising the first encryption key 140 assumes the value of the string of bits comprising the second encryption key 130. When all of the flags in the memory 230 (FIG. 2) are set, an update (UPDATE KEY) is invoked. A new string of bits, indicated by Key1 in the timing diagram 300, is, thereupon provided by the random bit generator 250, as explained above. The new string of bits becomes the new second encryption key 130 (indicated with dots in the background in the timing diagram 300). As data is written to the register file 110 (FIGS. 1 and 2) (denoted reg0, reg1, . . . reg14, reg15 in the timing diagram 300) the data is encrypted by the updated first encryption key 140 (indicated with dots in the background in the timing diagram 300). For example, data item data2 310 of reg0 is shown as having a dotted background, indicating that data item data2 of reg0 is now encrypted with the updated first encryption key 140.

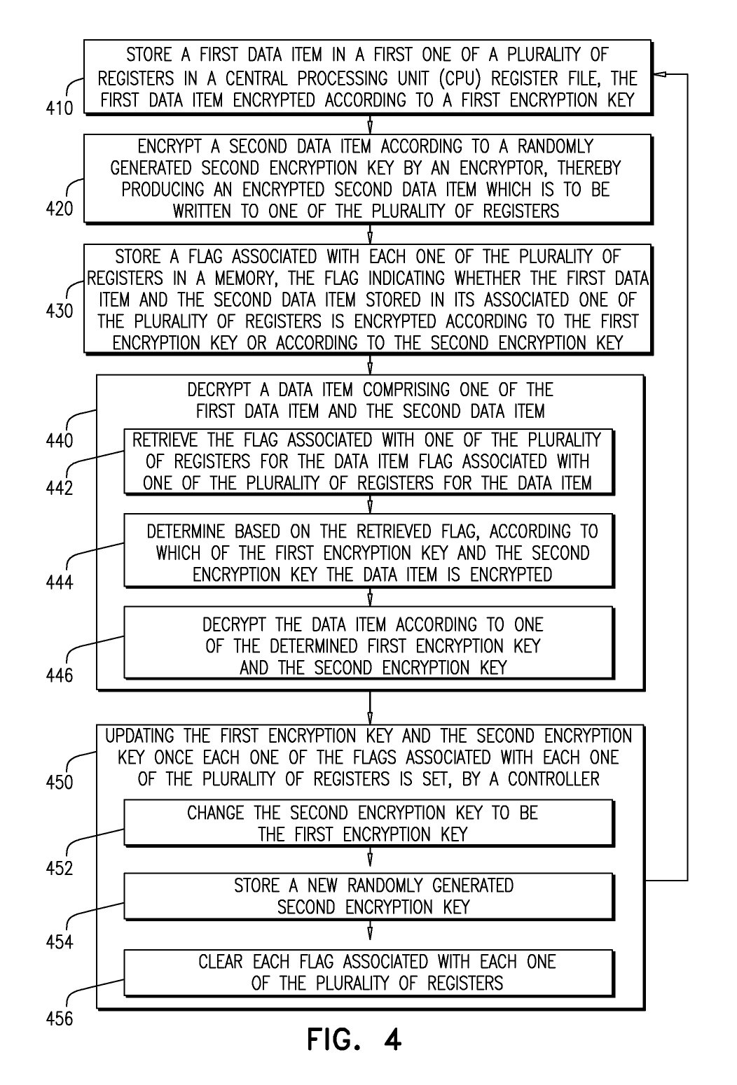

Reference is now made to FIG. 4, which is a flow chart is a flow chart of a method of operation for an embodiment of the present disclosure. At step 410 a first data item, which is encrypted according to a first encryption key, is stored in a first one of a plurality of registers in a central processing unit CPU register file.

An encryptor encrypts a second data item according to a randomly generated second encryption key, producing an encrypted second data item, which is to be written to one of the plurality of registers (step 420).

At step 430, a flag associated with each one of the plurality of registers is stored in a memory, the flag indicating whether the first data item and the second data item stored in its associated one of the plurality of registers is encrypted according to the first encryption key or according to the second encryption key.

At step 440 a data item, which comprises one of the first data item and the second data item, is decrypted. The decryption of the data item entails the following steps. At step 442 the flag associated with one of the plurality of registers for the data item is retrieved. At step 444, based on the retrieved flag, the decryptor determines according to which of the first encryption key and the second encryption key the data item is encrypted. At step 446, the data item is decrypted according to the determined one of the first encryption key and the second encryption key.

The first encryption key and the second encryption key is updated by a controlled once each one of the flags associated with each one of the plurality of registers is set (step 450). The updating entails the following steps. At step 452, the controller changes the second encryption key to be the first encryption key. At step 454 the controller stores a new randomly generated second encryption key. At step 456, the controller clears each flag associated with each one of the plurality of registers.

Upon a new first data item needing to be stored, the method can then return to step 410.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system comprising:
a central processing unit (CPU) having a register file comprising a plurality of registers, the register file operative to store a first data item in a first one of the plurality of registers, the first data item encrypted according to a first encryption key;
an encryptor operative to encrypt a data item, which encrypts a second data item according to a randomly generated second encryption key, the second data item to be written to one of the plurality of registers;
a memory operative to store a flag associated with each one of the plurality of registers, the flag indicating whether the first data item and the second data item stored in its associated one of the plurality of registers is encrypted according to the first encryption key or according to the second encryption key;
a decryptor operative to decrypt a data item by retrieving the flag associated with one of the plurality of registers for the data item, and determine, based on the retrieved flag, according to which of the first encryption key and the second encryption key the data item is encrypted, and thereupon, to decrypt the data item according to one of the first encryption key and the second encryption key, as determined, wherein the data item comprises one of the first data item and the second data item; and
a controller to update the first encryption key and the second encryption key once each one of the flags associated with each one of the plurality of registers is set, whereupon the controller is operative to:
change the second encryption key to be the first encryption key;
store a new randomly generated second encryption key; and
clear each flag associated with each one of the plurality of registers.

2. The system according to claim 1 wherein the second data item is to be written to the first one of the plurality of registers.

3. The system according to claim 1 wherein the second data item is to be written to a second one of the plurality of registers.

4. The system according to claim 1 wherein the randomly generated second encryption key is randomly generated by a pseudo-random bit generator.

5. The system according to claim 1 wherein the randomly generated second encryption key is randomly generated by a true-random bit generator.

6. The system according to claim 1 wherein the randomly generated second encryption key has been processed by a shift register prior to being provided to the encryptor.

7. The system according to claim 6 wherein the shift register comprises a linear-feedback shift register.

8. A method comprising:
storing a first data item in a first one of a plurality of registers in a central processing unit (CPU) register file, the first data item encrypted according to a first encryption key;
encrypting a second data item according to a randomly generated second encryption key, by an encryptor, thereby producing an encrypted second data item to be written to one of the plurality of registers;
storing a flag associated with each one of the plurality of registers in a memory, the flag indicating whether the first data item and the second data item stored in its associated one of the plurality of registers is encrypted according to the first encryption key or according to the second encryption key;
decrypting a data item by:
retrieving the flag associated with one of the plurality of registers for the data item;
determining based on the retrieved flag, according to which of the first encryption key and the second encryption key the data item is encrypted; and thereupon
decrypting the data item according to one of the first encryption key and the second encryption key, as determined,
wherein the data item comprises one of the first data item and the second data item; and
updating the first encryption key and the second encryption key once each one of the flags associated with each one of the plurality of registers is set, by a controller, the controller:
changing the second encryption key to be the first encryption key;
storing a new randomly generated second encryption key; and
clearing each flag associated with each one of the plurality of registers.

9. The method according to claim 8 wherein the second data item is to be written to the first one of the plurality of registers.

10. The method according to claim 8 wherein the second data item is to be written to a second one of the plurality of registers.

11. The method according to claim 8 wherein the randomly generated second encryption key is randomly generated by a pseudo-random bit generator.

12. The method according to claim 8 wherein the randomly generated second encryption key is randomly generated by a true-random bit generator.

13. The method according to claim 8 wherein the randomly generated second encryption key has been processed by a shift register prior to being provided to the encryptor.

14. The method according to claim 13 wherein the shift register comprises a linear-feedback shift register.

15. An apparatus comprising
means for storing a first data item in a first one of a plurality of registers in a central processing unit (CPU) register file, the first data item encrypted according to a first encryption key;
means for encrypting a second data item according to a randomly generated second encryption key, the second data item to be written to one of the plurality of registers;
means for storing a flag associated with each one of the plurality of registers in a memory the flag indicating whether a data item stored in the associated one of the plurality of registers is encrypted according to the first encryption key or according to the second encryption key;
means for decrypting a data item by retrieving the flag associated with one of the plurality of registers for the data item, and determining, based on the retrieved flag, according to which of the first encryption key and the second encryption key the data item is encrypted, and thereupon, to decrypt the data item according to one of the first encryption key and the second encryption key, as determined, wherein the data item comprises one of the first data item and the second data item; and
means for updating the first encryption key and the second encryption key once each one of the flags associated with each one of the plurality of registers is set, by controller means, the controller means comprising:
means for changing the second encryption key to be the first encryption key;
means for storing a new randomly generated second encryption key; and
means for clearing each flag associated with each one of the plurality of registers.

16. The apparatus according to claim 15 wherein the second data item is to be written to the first one of the plurality of registers.

17. The apparatus according to claim 15 wherein the second data item is to be written to a second one of the plurality of registers.

18. The apparatus according to claim 15 wherein the randomly generated second encryption key is randomly generated by a pseudo-random bit generator.

19. The apparatus according to claim 15 wherein the randomly generated second encryption key is randomly generated by a true-random bit generator.

20. The apparatus according to claim 15 wherein the randomly generated second encryption key has been processed by a shift register prior to being provided to the encryptor.
